(19) United States
(12) Patent Application Publication
(10) Pub. No.: US 2004/0177045 A1
(43) Pub. Date: Sep. 9, 2004

(54) Three-legacy mode payment card with parametric authentication and data input elements

(76) Inventor: Kerry Dennis Brown, Portola Valley, CA (US)

Correspondence Address: RICHARD BREWSTER MAIN, PATENT ATTORNEY, P.O. BOX 1859, LOS ALTOS, CA, 94022, US

(21) Appl. No.: 10/800,821

(22) Filed: Mar. 15, 2004

Related U.S. Application Data
(63) Continuation-in-part of application No. 09/837,115, filed on Apr. 17, 2001.
(63) Continuation-in-part of application No. 09/875,555, filed on Jun. 5, 2001.
(63) Continuation-in-part of application No. 10/738,376, filed on Dec. 17, 2003.

(51) Int. Cl. G06F 17/60

(52) U.S. Cl. 705/65

(57) ABSTRACT

A payment card comprises a plastic card and operates with three different legacy payment systems. A magnetic stripe with user account data allows card use in traditional point-of-sale magnetic card readers. A dual-input crypto-processor embedded in the card provides for contact/contactless smart card operation. A user input provides for user authentication by the crypto-processor. Internal to the plastic card, and behind the magnetic stripe, a magnetic array includes a number of fixed-position magnetic write heads that allow the user account data to be automatically modified by the crypto-processor.

### RELATED APPLICATION

This Application is a Continuation-In-Part of U.S. patent application Ser. No. 10/738,376, filed Dec. 17, 2003, by the present inventor, Kerry Dennis BROWN, and titled PROGRAMMABLE MAGNETIC DATA STORAGE CARD. Such is incorporated by reference as if fully set forth herein.

### BACKGROUND OF THE INVENTION

1. Field of the Invention

The present invention relates to a payment card, and more particularly to payment cards with contact/contactless smartcard interfaces, and an internally writeable magnetic data stripe readable by legacy card readers.

2. Description of Related Art

Credit card and debit card use and systems have become ubiquitous throughout the world. Originally, credit cards simply carried raised numbers that were transferred to a carbon copy with a card-swiping machine. The merchant simply accepted any card presented. Spending limits and printed lists of lost/stolen cards were ineffective in preventing fraud and other financial losses. So merchants were required to telephone a transaction authorization center to get pre-approval of the transaction. These pre-approvals were initially required only for purchases above a certain threshold, but as time went on the amounts needing authorization dropped lower and lower. The volume of telephone traffic grew too great, and more automated authorization systems allowed faster, easier, and verified transactions. Magnetic stripes on the backs of these payment cards started to appear and that allowed computers to be used at both ends of the call.

The magnetic data on the stripe on the back of payment cards now contains a standardized format and encoding. The raised letters and numbers on the plastic cards are now rarely used or even read. This then gave rise to “skimming” devices that could be used by some unscrupulous merchant employees to electronically scan and save the information from many customers' cards. Reproducing an embossed card complete with photos is then rather easy.

Smartcards were first introduced around 1994 with embedded single-chip cryptoprocessors and contact interfaces. These required a new reader that could probe the smartcard's contact pad and electronically interrogate the card. Cards could be authenticated this way, but the contact interfaces proved to be troublesome. Such cards have not gained wide acceptance because new readers needed to be installed.

Dual interface smartcards started to appear around 2000. Such supported both contact (e.g., ISO/IEC-7816) and contactless (e.g., ISO/IEC-14443) interfaces, and used two completely independent cryptoprocessors and interfaces. They are therefore relatively expensive, because of the duplication. The independence of the two cryptoprocessors and interfaces meant that each had to be updated individually, the two may not talk to one another.

Typical dual interface smart cards support both contact and Type-A and/or Type-B antenna structures and the corresponding operating frequencies. Type A has a range of about 10 cm, and type B has a range of about 5 cm. Type B supports a higher data rate, but has proven to be the less popular because of the shorter range.

Dual-input smartcard cryptoprocessors started to become available in 2004, e.g., Philips Semiconductors family of 8-bit MIFARE® PROX dual interface smart card controllers. These use one IC with a crypto co-processor that has both contact and contactless interfaces. Updating the data through either interface is effective for both interfaces. The total cost of a smartcard using dual-input devices is much closer to the original single-chip cryptoprocessors with contact interfaces.

The proliferation of magnetic, contact, and contactless technologies is causing chaos, and the huge installed base of magnetic point-of-sale readers in the United States has been inhibiting the transition to smartcards, a USA cost, estimated by American Express in 2002, of approximately $4-14 billion dollars. What is needed is a transitional payment card that can continue to support magnetic reading while also being able to respond to smartcard readers. It further would be advantageous to have a payment card that can self-authenticate its users. Additionally, a card with EMV (Europay-MasterCard-Visa) security features of a smartcard and the transaction communications features compatible with magnetic stripe transaction acceptance systems and processing infrastructure.

### SUMMARY OF THE INVENTION

Briefly, a payment card embodiment of the present invention comprises a plastic card and operates with three different legacy payment systems. A magnetic stripe with user account data allows card use in traditional point-of-sale magnetic card readers. A dual-input crypto-processor embedded in the card provides for contact/contactless smart card operation. A user input provides for user authentication by the crypto-processor. Internal to the plastic card, and behind the magnetic stripe, a magnetic array includes a number of fixed-position magnetic write heads that allow the user account data to be automatically modified by the crypto-processor and support circuitry.

An advantage of the present invention is a payment card is provided for use with three major existing legacy systems.

A further advantage of the present invention is a payment card is provided that can authenticate the user to the card.

A still further advantage of the present invention is that a payment card is provided that does not require hardware or software changes to merchant point-of-sale terminals.

Another advantage of the present invention is that one card can express the personalities of several different kinds of payment cards issued by independent payment processors.

Another advantage of the present invention is a payment card that can generate a new account number upon each usage, and by doing so, authenticate itself to the transaction infrastructure.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of a payment card embodiment of the present invention;

FIG. 2 is a functional block diagram of a legacy magnetic card and reader embodiment of the present invention;

FIG. 3 is a state diagram of a card authentication process embodiment of the present invention; and

FIG. 4 is a perspective diagram of a magnetic array embodiment of the present invention as can be used in the devices of FIGS. 1-3.

### DETAILED DESCRIPTION OF THE INVENTION

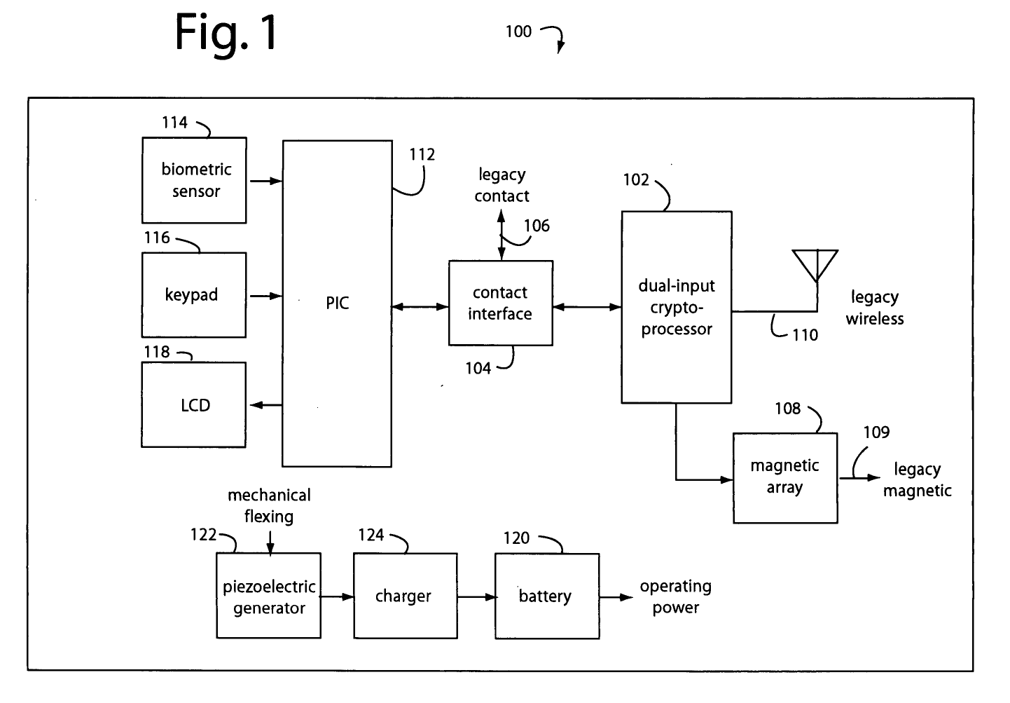

FIG. 1 illustrates a payment card embodiment of the present invention, and is referred to herein by the general reference numeral 100. Payment card 100 operates in any of three ways, e.g., (a) as a typical magnetic stripe card, (b) as a typical contact-mode smart card, and (c) as a typical wireless (proximity) smart card. It is implemented in the familiar credit/debit card format as a plastic wallet card with a magnetic stripe on its back. For example, in the ISO/IEC-7810 format. The payment card 100 comprises a dual-input crypto-processor 102 with a contact interface 104, e.g., ISO/IEC-7816. For example, a Philips Semiconductor type P8RF6016 triple-DES secure dual interface smart card IC could be used. Surface contacts on the card provide a conventional legacy contact 106 that can be used by traditional contact-mode card readers. A magnetic array 108 is arranged on the back of the card and presents what appears to be an ordinary magnetic stripe 109 encoded with appropriate bank and user information for a conventional magnetic card reader. Such readers are ubiquitous throughout the world at point-of-sale terminals. An antenna 110 provides wireless interface to conventional wireless smart card readers, e.g., ISO/IEC-14443-2 which operates at 13.56 MHz.

Particular details on the construction and operation of the magnetic array are included in the parent of the present application, U.S. patent application Ser. No. 10/738,376, filed Dec. 17, 2003, by the present inventor, Kerry Dennis BROWN, and titled PROGRAMMABLE MAGNETIC DATA STORAGE CARD. In addition, the data sent to the magnetic array 108 can be withheld until the user authenticates themselves to the smartcard 100. And such data will only be readable by a magnetic reader or smartcard reader for only a limited time or limited number of swipes or contact/contactless transactions.

An economic way of implementing payment card 100 is to use commercially available dual-input crypto-processors for processor 102 because they inherently come with the contact interface 104. This then can be easily interfaced to a low-power microcontroller 112, e.g., a Microchip programmable interface controller (PIC). In one embodiment, the payment card 100 includes a biometric sensor 114 that can sense some physical attribute about the user. For example, a fingerprint or signature input through a scanner or pressure sensor array. In other embodiments, the payment card 100 includes a keypad 116 with which a user can select a card personality and enter a personal identification number (PIN), password, or other data. Such personality selection can, e.g., be a choice amongst VISA, MasterCard, American Express, etc., so the payment card 100 presents the corresponding account and user numbers in the required formats for the particular bank and payment processor. A liquid crystal display (LCD) 118 in its simplest form presents a blinking indication that keypad input has been accepted, the card is awake and active, etc. A more complex LCD 118 can be used to display text message to the user in alternative embodiments of the present invention.

The communication between PIC 112 and dual-input crypto-processor 102 is such that each digit of a PIN entered is forwarded as it is entered. The whole PIN is not sent essentially in parallel. Such strategy makes the hacking of the card and access to user data more difficult. The PIC 112 does not store the PIN, only individual digits and only long enough to receive them from the keypad 116 and forward them on.

An embedded power source is needed by payment card 100 that can last for the needed service life of a typical smartcard, e.g., about eighteen months to four years. A battery 120 is included. In more complex embodiments, a piezoelectric generator 122 and charger 124 can be used that converts incidental temperature excursions and mechanical flexing of the card into electrical power that can charge a storage capacitor or help maintain battery 120. The piezoelectric generator 122 comprises a piezoelectric crystal arranged, e.g., to receive mechanical energy from card flexing and/or keypad use. The charger 124 converts the alternating current (AC) received into direct current (DC) and steps it up to a voltage that will charge the battery. Alternative embodiments can include embedded photovoltaic cells to power the card or charge the battery.

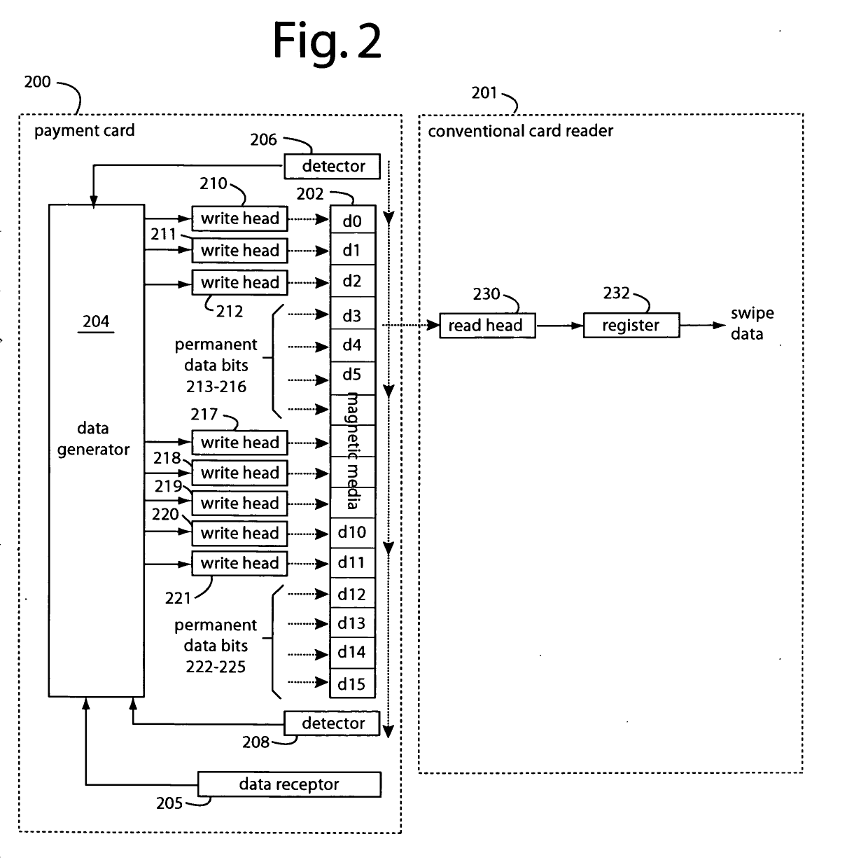

FIG. 2 illustrates a payment card embodiment of the present invention, and is referred to herein by the general reference numeral 200. In particular, FIG. 2 details the way magnetic array 108 and the legacy magnetic interface 109 can operate in the context of FIG. 1.

A conventional, “legacy”, merchant point-of-sale magnetic-stripe card reader 201 is used to read user account data recorded on a magnetic stripe 202 on the payment card 200. Such is used by a merchant in a traditional way, the payment card 200 appears and functions like an ordinary debit, credit, loyalty, prepay, and similar cards with a magnetic stripe on the back.

User account data is recorded on the magnetic stripe 202 using industry-standard formats and encoding. For example, ISO/IEC-7810, ISO/IEC-7811(-1:6), and ISO/IEC-7813, available from American National Standards Institute (NYC, N.Y.). These standards specify the physical characteristics of the cards, embossing, low-coercivity magnetic stripe media characteristics, location of embossed characters, location of data tracks 2-3, high-coercivity magnetic stripe media characteristics, and financial transaction cards. A typical Track-1, as defined by the International Air Transport Association (IATA), is seventy-nine alphanumeric characters recorded at 210-bits-per-inch (bpi) with 7-bit encoding. A typical Track-2, as defined by the American Bankers Association (ABA), is forty numeric characters at 75-bpi with 5-bit encoding, and Track-3 (ISO/IEC-4909) is typically one hundred and seven numeric characters at 210-bpi with 5-bit encoding. Each track has starting and ending sentinels, and a longitudinal redundancy check character (LRC). The Track-1 format includes user primary account information, user name, expiration date, service code, and discretionary data. These tracks conform to the ISO/IEC/IEC Standards 7810, 7811-1-6, and 7813, or other suitable formats.

The magnetic stripe 202 is located on the back surface of payment card 200. A data generator 204, e.g., implemented with a microprocessor, receives its initial programming and personalization data from a data receptor 205. For example, such data receptor 205 can be implemented as a serial inductor placed under the magnetic stripe which is excited by a standard magnetic card writer. Additionally, the data may be installed at the card issuer, bank agency, or manufacturer by existing legacy methods. The data received is stored in non-volatile memory. Alternatively, the data receptor 205 can be a radio frequency antenna and receiver, typical to ISO/IEC/IEC Specifications 24443 and 25693. The data generator 204 may be part of a secure processor that can do cryptographic processing, similar to Europay-Mastercard-Visa (EMV) cryptoprocessors used in prior art “smart cards”.

Card-swipes generate detection sensing signals from one or a pair of detectors 206 and 208. These are embedded at one or each end of magnetic stripe 202 and can sense the typical pressure applied by a magnetic read head in a scanner. A first set of magnetic-transducer write heads 210-212 are located immediately under bit positions d0-d2 of magnetic stripe 202. The data values of these bits can be controlled by data generator 204. Therefore, bit positions d0-d2 are programmable.

Such set of magnetic-transducer write heads 210-212 constitutes an array that can be fabricated as a single device and applied in many other applications besides payment cards. Embodiments of the present invention combine parallel fixed-position write heads on one side of a thin, planar magnetic media, and a moving serial read head on the opposite side. Such operation resembles a parallel-in, serial-out shift register.

A next set of bit positions 213-216 (d3-d6) of magnetic stripe 202 are fixed, and not programmable by data generator 204. A conventional card programmer is used by the card issuer to program these data bits. A second set of magnetic write heads 217-221 are located under bit positions d7-d11 of magnetic stripe 202. The data values of these bits can also be controlled by data generator 204 and are therefore programmable. A last set of bit positions 222-225 (d12-d15) of magnetic stripe 202 are fixed, and not programmable by data generator 204. In alternative embodiments of the present invention, as few as one bit is programmable with a corresponding write head connected to data generator 204, or as many as all of the bits in all of the tracks.

The legacy card reader 201 is a conventional commercial unit as are already typically deployed throughout the world, but especially in the United States. Such deployment in the United States is so deep and widespread, that conversion to contact and contactless smartcard systems has been inhibited by merchant reluctance for more purchases, employee training, counter space, and other concerns.

It is an important aspect of the present invention that the outward use of the payment card 200 not require any modification of the behavior of the user, nor require any special types of card readers 201. Such is a distinguishing characteristic and a principle reason that embodiments of the present invention would be commercially successful. The card reader 201 has a magnetic-transducer read head 230 that is manually translated along the length of data stripe 202. It serially reads data bits d0-d15 and these are converted to parallel digital data by a register 232.

The magnetic-transducer write heads 210-212 and 217-221 must be very thin and small, as they must fit within the relatively thin body of a plastic payment card, and be packed dense enough to conform to the standard recording bit densities. Integrated combinations of micro-electro-mechanical systems (MEMS) nanotechnology, and longitudinal and perpendicular ferromagnetics are therefore useful in implementations that use standard semiconductor and magnetic recording thin-film technologies.

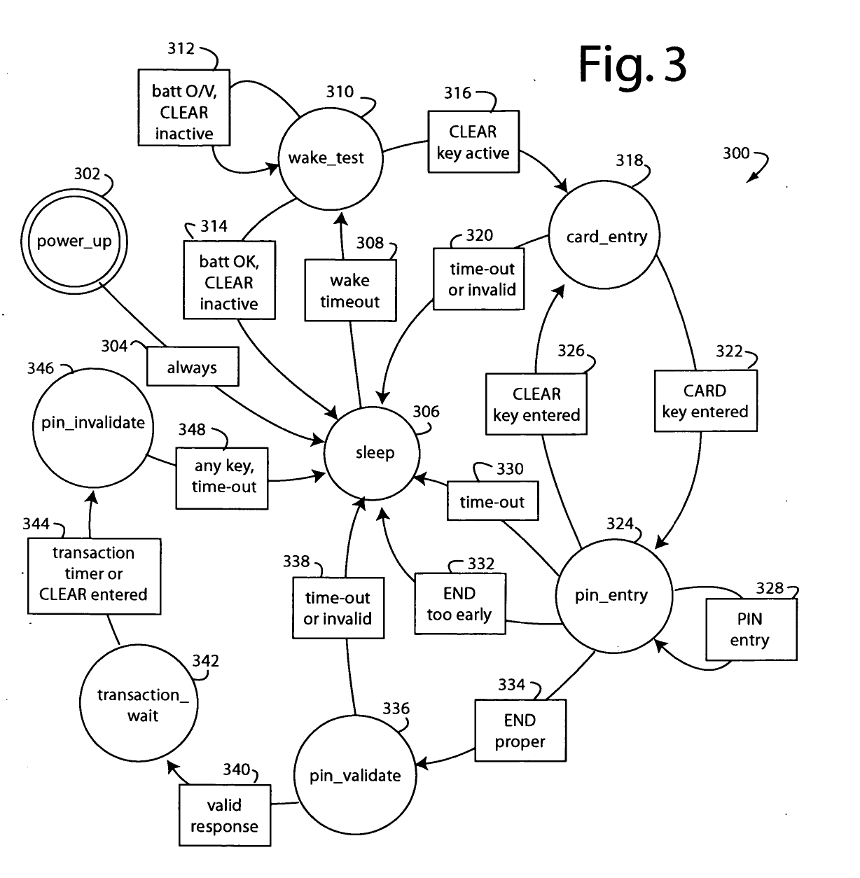

FIG. 3 represents a card authentication process embodiment of the present invention, and is referred to herein by the general reference numeral 300. Such process details the way that the processor 102 (FIG. 1) interacts with keypad 116 and LCD 118 in one embodiment of the present invention. Here, the keypad includes digits 0-9, CLEAR, and ENTER keys.

Process 300 comprises a power up state 302 that passes through an “always” condition 304 to a sleep state 306. A “wake timeout” condition 308 occurs when a wake-up timer times out. A wake_test state 310 checks battery condition and the CLEAR key. A condition 312 causes a loop back if the battery is within proper operating voltage range and the CLEAR key is inactive. If the battery is in range and the CLEAR key is inactive, a condition 314 returns to sleep state 306. But if the user has pressed the CLEAR key, a condition 316 passes to a card₁₃ entry state 318. The LCD is caused to blink at 1.0 Hz. A time-out for waiting for another key to be pressed, or an invalid key being entered, causes a condition 320 to return to sleep process 306.

If a CARD key is entered, a condition 322 passes to a pin_entry state 324. If CLEAR key was entered, a condition 326 returns to card_entry state 318. The LCD is caused to blink at 1.0 Hz. A PIN entry condition 328 processes each entry. If the user takes too long to enter the PIN, a time-out condition 330 returns to sleep state 306. If the ENTER key is pressed too soon, e.g., not enough PIN digits have been entered, a condition 332 returns to sleep state 306. If a proper number of PIN digit entries have been made, and that was followed by the ENTER key, a condition 334 passes to a pin_validate state 336.

If the PIN entered is invalid or a time-out has occurred, a condition 338 returns to sleep state 306. Otherwise, a valid-response condition 340 passes to a transaction_wait state 342. The LCD is caused to blink at 0.5 Hz. A transaction timer or CLEAR key entered condition 344 passes to a pin₁₃ invalidate state 346. Any key being pressed or a time-out in a condition 348 passes to the sleep state 306. This process may be used in conjunction with a smart card cryptoprocessor to unlock encrypted card data to be released for legacy transaction processes described herein and typical for magnetic stripe and smart cards.

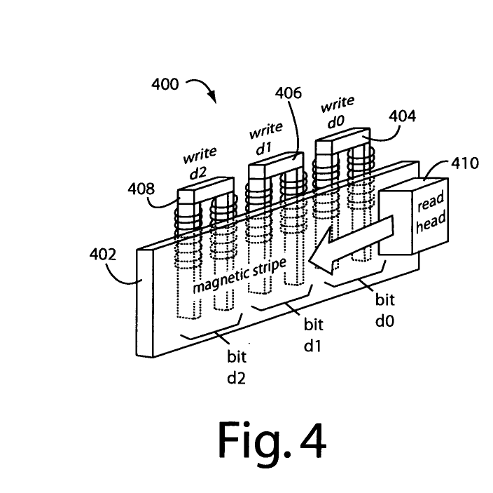

FIG. 4 illustrates a magnetic data storage array embodiment of the present invention, and is referred to by the general reference numeral 400. The magnetic data storage array 400 includes a magnetic stripe 402 that mimics those commonly found on the backs of credit cards, debit cards, access cards, and drivers licenses. In alternative embodiments of the present invention, array 400 can be a two-dimensional array, and not just a single track.

Here in FIG. 4, magnetic data bits d0-d2 are arranged in a single track. A set of fixed-position write heads 404, 406, and 408 respectively write and rewrite magnetic data bits d0-d2. A moving, scanning read head 410 in a legacy magnetic card reader is used to read out the data written.

Parts of magnetic data storage array 400 can be implemented with MEMS technology. In general, MEMS is the integration of mechanical elements, sensors, actuators, and electronics on a common substrate using microfabrication technology. Electronics devices are typically fabricated with CMOS, bipolar, or BICMOS integrated circuit processes. Micromechanical components can be fabricated using compatible “micromachining” processes that selectively etch away parts of a processing wafer, or add new structural layers to form mechanical and electromechanical devices.

In the present case, MEMS technology can be used to fabricate coils that wind around Permalloy magnetic cores with gaps to produce very tiny magnetic transducer write heads. For example, a magnetic transducer write head that would be useful in the payment card 100 of FIG. 1 would have a gap length of 1-50 microns, a core length of 100-250 microns, a write track width of 1000-2500 microns, and a read track width of 1000 microns. Nickel-iron core media permeability would be greater than 2000, and cobalt-platinum or gamma ferric oxide media permeability would be greater than 2.0, and the media coercivity would be a minimum of 300 Oe.

A parallel array static MEMS (S-MEMS) device is a magnetic transducer which will allow information to be written in-situ on the data tracks of a standard form factor magnetic stripe card. In a practical application, an array of twenty-five individual magnetic bit cells can be located at one end of an ISO/IEC/IEC 7811 standard magnetic media. Such a stripe includes some permanent encoding, as well as a region in which data patterns can be written by arrays of magnetic heads attached to a low-coercivity magnetic stripe.

Each cell of such parallel array is independently electronically addressed. Write transducer current may flow in one direction or the other, depending on the desired polarity of the magnetic data bits. The magnetic stripe transaction reader operates by detection of magnetic domain transitions within an F2F scheme typical of such cards and, therefore, magnetic domain reversal is not necessary. A prototype write head included a high permeability NiFe core with electroplated windings of copper wires. For example, a useful write head has a z-dimension (track width) of 1000-2500 microns, a width of 100 microns in the x-direction, and a height in the y-direction of approximately 20 microns. There are four coil turns around each pole piece, for a total of eight. The cross sectional area of the coil was estimated at four microns square, with a three micron spacing. Total length in the x-direction, including core and coils, was 150 microns, and about a ten micron spacing between adjacent magnetic cells.

Transaction process embodiments of the present invention embed an algorithm with unique user data in a cryptoprocessor. For example, a method for a transaction process embeds an algorithm that encodes unique user data in a cryptoprocessor. It requests a new unique transaction encoding to be issued by using the cryptoprocessor to process the algorithm and to generate a data suited to a card-acceptance system pre-processing requirements. A conventional transaction infrastructure and server can then be used to derive from the number the unique user data. The new unique transaction encoding can be communicated to the conventional transaction infrastructure and server by a smart card contact or proximity connection. The new unique transaction encoding can be communicated to the conventional transaction infrastructure and server by a reprogrammable magnetic stripe on a card read by a reader. Such is useful in validating and approving point-of-sale financial transactions.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is

1. A payment card, comprising:
a user-sensor for accepting a user input;
a processor connected to the user-sensor and providing for user authentication;
a contact interface connected to the processor and providing for communication with a contact-type smartcard reader;
a wireless interface connected to the processor and providing for communication with a contactless-type smartcard reader;
a stripe of magnetic material having a longitudinal length, and a front side and a back side, and able to store electronic data as a magnetic recording comprising a plurality of bits;
a magnetic write head permanently positioned on said back side of the stripe at a particular data bit of one of said plurality of bits, and providing for electronic-magnetic alteration of a data bit magnetically readable on said front side;
a magnetic recording serially accessible to a longitudinally moving read head on said front side of the stripe that includes said data bit affected by the magnetic write head; and
a plastic card in which all the other elements are disposed.

2. The payment card of claim 1, wherein:
the user-sensor includes a keypad for user entry of a password.

3. The payment card of claim 1, wherein:
the user-sensor includes a biometric sensor for collecting a physical characteristic of the user.

4. The payment card of claim 1, wherein:
the user-sensor includes a biometric sensor for collecting at least one of a signature or a fingerprint of the user and such is used by the processor to authenticate the user.

5. The payment card of claim 1, wherein:
the processor includes a secure dual-interface smartcard integrated circuit.

6. The payment card of claim 1, wherein:
the processor includes a programmable interface controller (PIC) connected to a contact interface of a secure dual-interface smartcard integrated circuit.

7. The payment card of claim 6, wherein:
the PIC does not store more than one digit of a user password being entered before sending it on to said contact interface of said secure dual-interface smartcard integrated circuit.

8. The payment card of claim 6, wherein:
the PIC does not store a whole user password entered one digit at a time.

9. The payment card of claim 1, further comprising:
a financial account number of a user encoded within the magnetic recording; and
a controller connected to the magnetic write head and providing for a subsequent obfuscation of the financial account number by re-recording of said data bit.

10. The payment card of claim 1, further comprising:
a usage-counter record encoded within the magnetic recording; and
a controller connected to the magnetic write head and providing for a subsequent incrementing of the usage-counter record by re-recording said data bit.

11. The payment card of claim 10, further comprising:
detectors connected to signal the controller when a reading of data in the magnetic recording has occurred.

12. The payment card of claim 1, further comprising:
a piezoelectric generator connected to power the processor.

13. The payment card of claim 1, further comprising:
a piezoelectric generator connected to charge a battery that powers the processor.

14. A method for operating a payment card, comprising:
providing a programmable magnetic array on a payment card; and
presenting valid data to said magnetic array for a limited time.

15. A method for operating a payment card, comprising:
providing a smartcard contact interface, a wireless smartcard contactless interface, and a programmable magnetic array on a single payment card; and
presenting valid data to said magnetic array for a limited time.

16. A method for operating a payment card, comprising:
providing a smartcard contact interface, a wireless smartcard contactless interface, and a programmable magnetic array on a single payment card;
requiring a user to enter a password on said single payment card; and
presenting valid data to said magnetic array for a limited time if the user is authenticated.

17. A method for operating a payment card, comprising:
providing a smartcard contact interface, a wireless smartcard contactless interface, and a programmable magnetic array on a single payment card;
requiring a user to enter a biometric on said single payment card; and
presenting valid user account data to a corresponding card reader for a limited time if the user is authenticated.

18. A method for a transaction process, comprising:
embedding an algorithm that encodes unique user data in a cryptoprocessor;
requesting a new unique transaction encoding to be issued by using said cryptoprocessor to process said algorithm and to generate a data suited to a card-acceptance system pre-processing requirements; and
using a conventional transaction infrastructure and server to derive from said number said unique user data.

19. The method of claim 18, further comprising:
communicating said new unique transaction encoding to said conventional transaction infrastructure and server by a smart card contact or proximity connection.

20. The method of claim 18, further comprising:
communicating said new unique transaction encoding to said conventional transaction infrastructure and server by a reprogrammable magnetic stripe on a card read by a reader.
